(19) United States
(12) Patent Application Publication
(10) Pub. No.: US 2020/0304325 A1
(43) Pub. Date: Sep. 24, 2020

(54) MAGNETIC PHYSICAL UNCLONABLE FUNCTION WITH MULTIPLE MAGNETIC COERCIVITIES

(71) Applicant: Lexmark International, Inc., Lexington, KY (US)

(72) Inventors: Gary Allen Denton, Lexington, KY (US); James Paul Drummond, Georgetown, KY (US); Robert Henry Musykens, Lexington, KY (US)

(21) Appl. No.: 16/825,372

(22) Filed: Mar. 20, 2020

Related U.S. Application Data
(60) Provisional application No. 62/822,555, filed on Mar. 22, 2019.

(51) Int. Cl. H04L 9/32; G06K 19/06

(52) U.S. Cl. CPC H04L 9/3278; G06K 19/06196

(57) ABSTRACT

The use of two different magnetic coercivity materials in order to have both permanent and non-permanent content on the same security object is described. A security device is presented having a polymer matrix composite containing a uniform distribution of a low coercivity magnetic material such as, but not limited to, magnetite. In conjunction with this uniform background a random distribution of high coercivity magnetic material such as but not limited to an alloy of neodymium, iron, and boron (NdFeB) can be mixed within the first uniform background material to form a durable magnetic signature within the low coercivity uniform background. This can be achieved, for example, by compounding low and high coercivity materials in one compounding operation with one matrix material.

### PRIORITY CLAIM FROM PROVISIONAL APPLICATION

The present application is related to and claims priority under 35 U.S.C. 119(e) from U.S. provisional application No. 62/822,555, filed Mar. 22, 2019, titled “Magnetic PUF Objects with Multiple Magnetic Coercivities,” the content of which is hereby incorporated by reference herein in its entirety.

### CROSS REFERENCES TO RELATED APPLICATIONS

None.

### BACKGROUND

U.S. Pat. No. 9,553,582, titled “Physical Unclonable Functions Having Magnetic and Non-Magnetic Particles,” discloses a PUF (Physical Unclonable Function) that contains magnetic particles that generate a complex magnetic field near the surface of the PUF part. This magnetic field may be measured along a path and data corresponding to the magnetic field components recorded for later authentication of the PUF part. U.S. Pat. No. 9,608,828, titled “Elongated Physical Unclonable Function,” discloses the advantages of magnetizing the feed stock prior to the injection molding process to achieve a random orientation of the magnetization directions.

In these patents, flakes of an alloy of neodymium, iron, and boron (NdFeB) are cited as the preferred magnetic particles. These flakes are typically about 35 microns thick with irregular shapes varying in width from 100-500 microns but can be a variety of sizes. The NdFeB alloy is not easily magnetized because it has an intrinsic coercivity of around 9,000 Oersted. However, once magnetized, it has a residual induction of about 9,000 gauss, and the random locations and magnetic orientations of the flakes produce sharp peaks in the magnetic field strength of 10-30 gauss when measured at a distance of about 0.5 mm from the surface of the PUF.

### SUMMARY

This invention addresses the use of two different magnetic coercivity materials in order to have both permanent and non-permanent content on the same security object.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1A shows a typical magnetic profile for one of the magnetic ink character recognition physical unclonable function gears.

FIG. 1B is a close up of the central portion of FIG. 1A.

FIG. 2 shows a magnetic profile produced by touching a portion of the magnetic ink character recognition physical unclonable function gear to a striped magnetic rectangle with a surface field of over 400 gauss.

FIG. 3 shows a typical magnetic profile for a gear ring fabricated containing 10% NdFeB flakes and 25% MO4232 powder by weight at a specific radius from the center of the gear.

FIG. 4 shows the profile from FIG. 3 after the part was pressed against a striped magnetic rectangle with a surface field of over 400 gauss.

FIG. 5 shows the result of locally applying an AC magnetic field (˜300 gauss) to erase the effects of the striped magnet on FIG. 4.

FIG. 6 is a gear with a PUF disk.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having,” and variations thereof herein is meant to encompass the items listed thereafter and equivalents thereof as well as additional items.

Terms such as “about” and the like have a contextual meaning, are used to describe various characteristics of an object, and such terms have their ordinary and customary meaning to persons of ordinary skill in the pertinent art. Terms such as “about” and the like, in a first context mean “approximately” to an extent as understood by persons of ordinary skill in the pertinent art; and, in a second context, are used to describe various characteristics of an object, and in such second context mean “within a small percentage of” as understood by persons of ordinary skill in the pertinent art.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Spatially relative terms such as “top,” “bottom,” “front,” “back,” “rear,” and “side,” “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc., and are also not intended to be limiting. Like terms refer to like elements throughout the description.

This invention addresses the use of two different magnetic coercivity materials in order to have both permanent and non-permanent content on the same security object. In one embodiment of this innovation, an identification/security tag is presented, having a polymer matrix composite containing a uniform distribution of a low coercivity magnetic material such as, but not limited to, magnetite. In conjunction with this uniform background a random distribution of high coercivity magnetic material such as but not limited to an alloy of neodymium, iron, and boron (NdFeB) can be mixed within the first uniform background material to form a durable magnetic signature within the low coercivity uniform background. This can be achieved by compounding low and high coercivity materials in one compounding operation with one matrix material.

Or, in another embodiment, the low coercivity material could be compounded in a separate compounding operation to create pellets of uniform low coercivity magnetic particles in polymer matrix. In a second operation, the high coercivity particles could be compounded into the same type of polymer matrix material forming pellets of matrix resin with high coercivity magnetic particles. This second set of pellets could then be pre-magnetized. Using these two sets of pellets to thus mold a tag, results in a uniform low coercivity background material with random individual magnetized particles in this matrix.

In use, this high coercivity material could continue to be used as a physically unclonable unique signature for the tag, but the industry using the tag could use a simple magnetic writing head to write additional data on the background of low coercivity material without affecting the high coercivity material. By this method, a single magnetic reader could read both a permanent unique identifier and transient writeable data (such as an index, fiducial, volume reduction or other tracking information).

In another embodiment, these two described sets of pellets could be used in a “two shot” (co-injection) molding operation to create a part having regions with low coercivity and regions with high coercivity particles within the same part, and thus have writable and permanent regions in the part.

These devices could be used in a similar manner to those described above using a single reader to read permanent and transient data. In a variation on this embodiment, these separate regions could be joined by any of a number of joining operations such as, but not limited to, laser welding or ultrasonic welding.

Injection molded magnets are typically fully dense magnetic powders blended with a variety of polymer base materials. Depending on the combination of magnetic material and polymer selected, a wide range of final material properties are possible. The magnetic powders may be ferrite, NdFeB, or a composite of samarium and cobalt. The resins commonly used are Nylon 6/12 (poly(hexamethylene dodecanediamide)), Nylon 12 (poly(dodecano-12-lactam)), PPS (polyphenylene sulfide), and PMMA (polymethyl methacrylate).

Black MO4232 is a synthetic black magnetic iron oxide pigment (magnetite, ferrosoferric oxide) produced by Cathay Industries USA, Inc. This pigment is used in magnetic ink character recognition (“MICR”) toners. MICR toners are specialty toners used by the banking industry for check processing. Black MO4232 is acicular in shape, has a low magnetic coercivity, and has a high Curie temperature. Black MO4232 is long established in the magnetic ink and magnetic transfer ribbon industries and is used in specialty high-quality toner requiring high remnant magnetization. Black MO4232 complies with the Restriction of Hazardous (“RoHS”) regulations.

TABLE 1
Black MO4232 Magnetic and Physical Properties

| Property | Value | Unit |
|---|---|---|
| Hc, Coercivity | 310 | (Oe, VSM) |
| Sigma_M, Specific Magnetization | 87 | (emu/g) |
| Sigma_R, Remnant Magnetization | 32 | (emu/g) |
| Curie Temperature | 1085 | ° F. |
| Average Length | 0.45 | μm |
| Length/Width Ratio | 5:1 | |

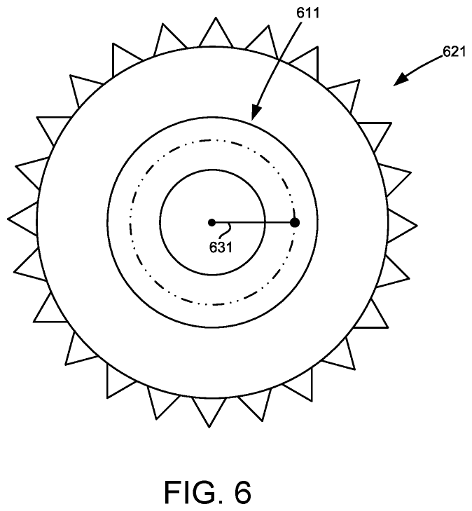

Sample disks 611, see FIG. 6, were injection molded containing approximately 25% by weight MICR powder (Black MO4232 from Cathay Industries USA) in PMMA resin. The MICR feed stock was pre-magnetized before being used in the injection molding process. The molded disks were about 62 mm in diameter and 1.2 mm thick. The disks were machined to produce rings with an inner diameter of about 20 mm and an outer diameter of 33 mm. The rings were mounted on drive gears 621 and the magnetic profiles were recorded at a specific radius 631 from the center of the gear over an approximately 1 mm band.

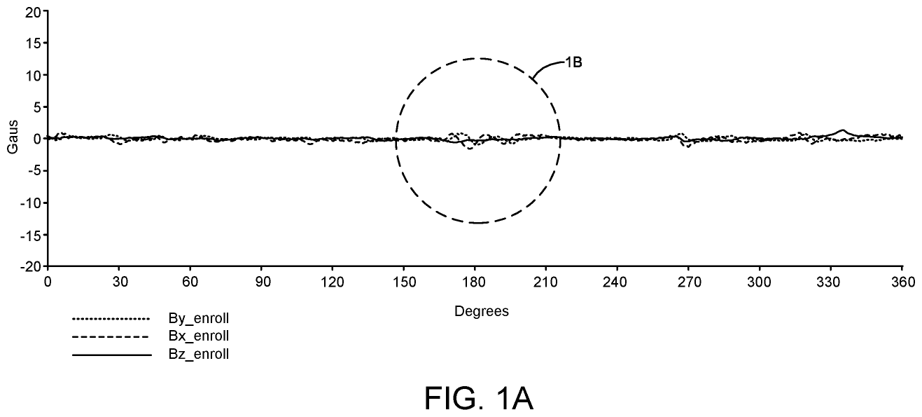

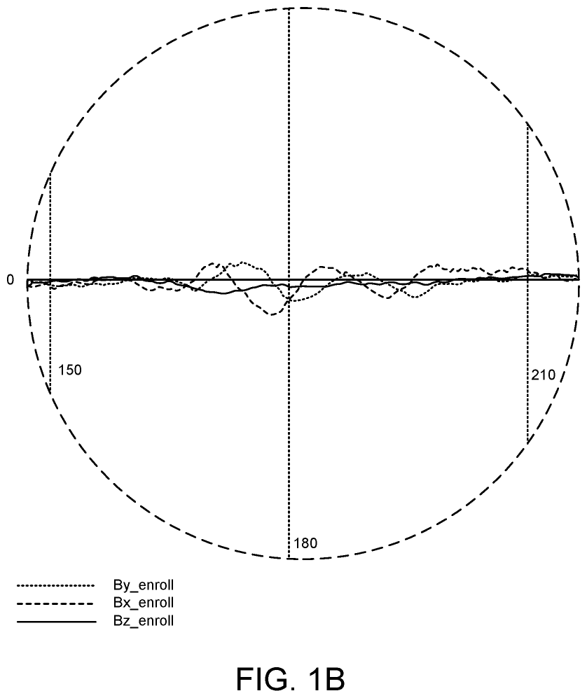

FIG. 1A shows a typical magnetic profile for one of the MICR PUF gears. FIG. 1B is a close up of the central portion of the magnetic profile. The magnetic profiles were generally less than 1 gauss in amplitude as molded. Finite element modeling predicted random magnetic profile amplitudes of over 5 gauss were possible. The low observed magnetic field amplitude is believed due to thorough mixing (homogenization) of the magnetite compound in the injection molding machine.

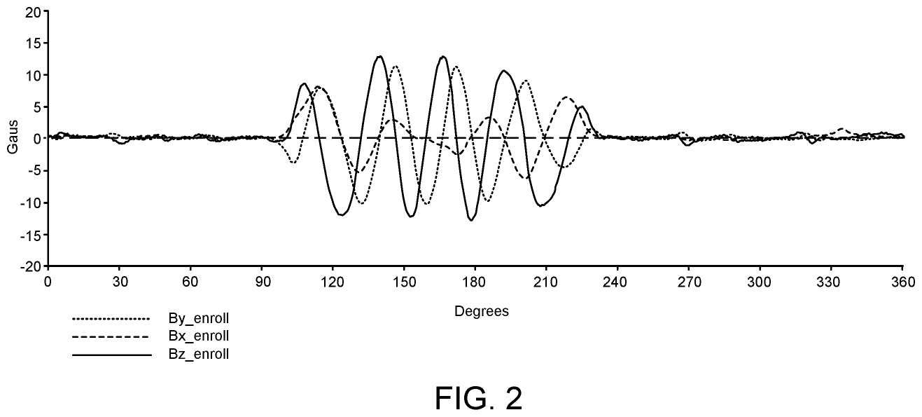

FIG. 2 shows a magnetic profile produced by touching a portion of the MICR PUF gear to a striped magnetic rectangle with a surface field of over 400 gauss. The magnetic profile amplitude of over 10 gauss demonstrates that this compound can be easily magnetized to produce magnetic profiles that are readable with low cost three-dimensional (“3D”) magnetometer integrated circuit chips.

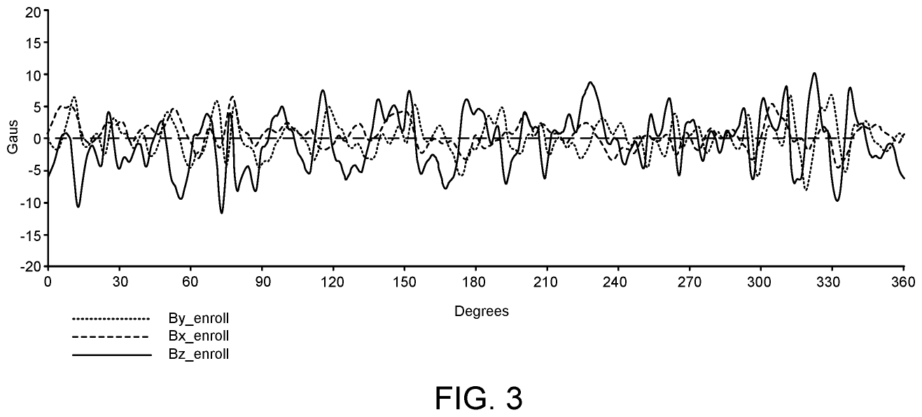

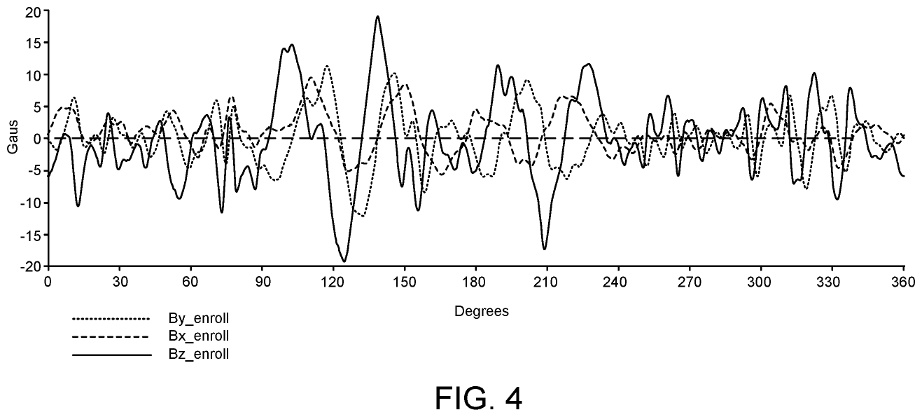

PUF gear rings were also fabricated containing 10% NdFeB flakes and 25% MO4232 powder by weight. FIG. 3 shows a typical magnetic profile for one of these rings at a specific radius from the center of the gear. FIG. 4 shows the same track's profile after the part was pressed against the striped magnet used in FIG. 2.

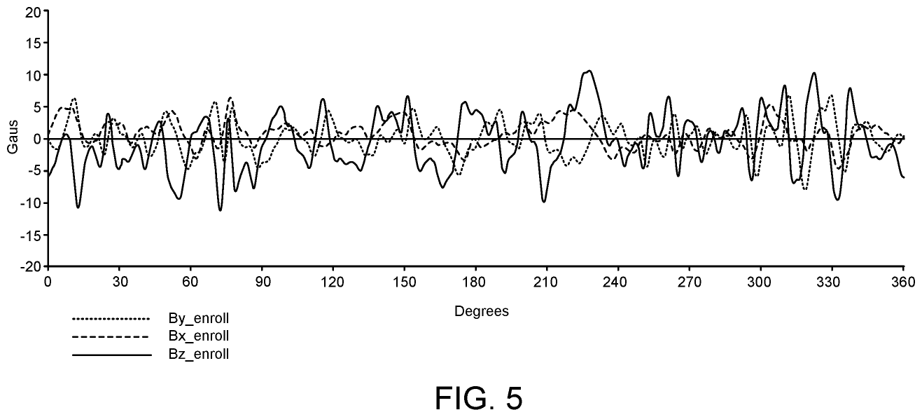

FIG. 5 shows the result of locally applying an AC magnetic field (˜300 gauss) to erase the effects of the striped magnet.

A magnetic PUF object is injection molded using a blend of feedstock pellets selected from Table 1 below. Since magnetite feedstocks are fine powders (mean particle size less than approximately 100 microns), it may be advantageous to incorporate this material into resins with higher melt temperatures to delay the melting point in the injection molding machine until shortly before the injection nozzle. Thus, a non-uniform distribution of the magnetite particles would be achieved. An alternate method to achieve random orientation of the MICR compound would be to apply an alternating magnetic field of 500-1000 Oersted to the melted feed stock shortly before it enters the molding cavity to magnetize the low coercivity particles.

TABLE 2
Feedstock Pellet Blend

| Feedstock | Plastic | | Weight % | Weight % |
|---|---|---|---|---|
| Type | Weight % | Plastic/Melt temp | NdFeB | Magnetite |
| 1 | 50% | PA-6, 12/190° C. | 20% | 30% |
| 2 | 70-80% | PA-6, 12/190° C. | 20-30% | 0% |
| 3 | 60-80% | PA-6, 10/215° C. | 0% | 20-40% |
| 4 | 50% | PPS/280° C. | 0% | 50% |

### Example 1

PUF parts are molded using a blend of Feedstock Nos. 2 and 3. The feedstock pellets containing magnetic material are magnetized before entering the injection molding machine. The injection molding machine's feed screw and heating is designed or modified so that it provides limited mixing of the melted material and does not produce a homogeneous part. The molded part may have visible swirls or bands of the two feedstocks, i.e., it will not appear homogeneous.

Within each band/domain of Feedstock No. 3, the magnetization direction may slowly vary with location in a random manner, producing a measurable contribution to the magnetic “fingerprint” of each PUF part, which is recorded and used for authentication at a later time.

If the PUF is attached to a printer toner cartridge, for example, when the toner cartridge is empty, an AC magnetic field may be applied to the PUF, resulting in the low coercivity magnetic material being erased or magnetized in a different pattern. This alteration of the magnetic fingerprint will cause the future authentications of this toner cartridge to fail and will impede the unauthorized refilling of the toner cartridge.

Alternatively, this PUF concept may be used for authenticating a user replaceable item at the beginning of life and the low coercivity pattern may be erased gradually over the life of the item, either in radial angle (X % of 360° radial path) or in amplitude. This implementation could for example prevent the item from being reset to new or “full of toner” condition when less than 30% of life remained for the item.

If the item is subjected to re-authentication later in life, the authentication algorithm could be written to accept a lower correlation or authentication test result depending on the amount of life remaining on the item. This would allow an authentic toner cartridge to be transferred between printers later in life, but it would block refilled cartridges after they had reached end of life.

### Example 2

PUF parts are molded using Feedstock No. 1. Conventional mixing of the melted feedstock during the injection molding process produces a homogeneous mixture of the materials. To produce regions with significant magnetization of the magnetite pigment particles, an alternating magnetic field may be applied to the melted material shortly before it enters the molding cavity. This will vary the magnetization direction of the MICR particles without affecting the magnetization of the NdFeB flakes. Once again, the MICR component of the magnetic field may be erased at the end of cartridge life if so desired.

### Example 3

PUF parts are molded using Feedstock No. 1. Conventional mixing of the melted feedstock during the injection molding process produces a homogeneous mixture of the materials. The molded parts will have a random magnetic fingerprint generated by the NdFeB flakes. The PUF object is subjected to a secondary magnetization step by bringing it into momentary contact with a permanent magnet. This permanent magnet preferably has a multiplicity of North and South poles which act to magnetize the low coercivity magnetite particles in the PUF object. This creates a complex magnetic fingerprint that can be used for authentication. Once again the MICR component of the magnetic field may be erased at the end of cartridge life if so desired to inhibit further usage of the associated toner cartridge. During the manufacturing enrollment procedures, the disk fingerprint could be enrolled both before and after the secondary permanent magnet magnetization step. This would allow a printer in the field to still distinguish a cartridge as a genuine/authentic cartridge even after it is empty and has been magnetically erased.

### Example 4

Feedstock No. 5 is extruded into a thin sheet or ribbon, i.e, less than approximately 0.5 mm in thickness. This material is cut into flakes and the flakes are compounded with Feedstock No. 2 to form pellets with both NdFeB and MICR flakes. These pellets are magnetized and used as feedstock to injection mold PUF objects. These PUF objects will have a mixture of high magnetic coercivity flakes and low coercivity flakes that generate random magnetic fingerprints. And at the end of cartridge life, the low coercivity flakes can be erased to alter the magnetic fingerprint and thereby prevent the cartridge from being authenticated.

### Example 5

PUF parts are molded in a two-shot molding process. On the first shot, Feedstock No. 2 is used to mold an inner ring of pre-magnetized high coercivity magnetic compound. On the second shot, Feedstock No. 3 is used to mold an outer ring of low coercivity magnetic compound. The magnetic fingerprint of the inner ring is measured and processed to generate enrollment data.

Variable data such as a PUF serial number, geography, toner load, etc., may be encrypted and written on the outer ring. If the data is written in approximately 0.5 mm wide radial stripes, then 100-200 bits of data may be read by a second Hall effect sensor chip in the printer in a manner similar to the reading of the PUF profile. This two-ring part may also be formed by molding each ring separately and then joining the rings in a secondary operation.

When the supply item has reached its end of life, the information on the outer ring may be erased and unauthorized refilling/reuse of the supply item may be detected and blocked. Similar to Example 1, the digital information on the outer ring may be erased in stages to indicate the remaining life for that item.

### Example 6

In an alternate form, PUF parts are molded in methods as in Example 5, however the parts are not necessarily uniform annular rings of material. The initial shot of high coercivity material may be a partial disc (in this example) having sections missing. The subsequent second shot (or part) could fill the gaps in the initial shot and create low coercivity (writable) sections within the same annular path. This could allow the same sensor traveling on a circular path to be used to read the signal from both the writable and permanent segments of the PUF. This writable segment could be used for a serial number for manufacturing, toner level, or for other short-term information.

The desirable characteristic of this example is that the single signal from the one sensor path could be used as the unique PUF signal for authentication, and part of this signal path can be written to include identification information as an integral part of the authentication data. This data would be needed in the signal in order to create a cloned PUF. However, when a PUF reaches end of life, this identification section can be rewritten or erased at which point the PUF would then fail authentication. However, since the PUF authentication data still contains “unclonable” permanent data from the high coercivity segment of the code, the cloner still cannot clone the PUF even though part of the code is writable.

The foregoing description of embodiments has been presented for purposes of illustration. It is not intended to be exhaustive or to limit the present disclosure to the precise steps and/or forms disclosed, and obviously many modifications and variations are possible in light of the above teaching. It is intended that the scope of the invention be defined by the claims appended hereto.

We claim:

1. A security device with both permanent and non-permanent content comprising:
a polymer matrix composite containing a uniform distribution of a low coercivity magnetic material;
a random distribution of high coercivity magnetic material within the polymer matrix, where the high coercivity magnetic material forms a durable magnetic signature within the low coercivity uniform background.

2. The security device of claim 1, wherein the low coercivity material is magnetite.

3. The security device of claim 1, wherein the high coercivity material is an alloy of neodymium, iron, and boron.

4. A method of making a security device with both permanent and non-permanent content comprising:
compounding low coercivity material with a first polymer matrix material in a first compounding operation to form pellets;
compounding high coercivity particles with a second polymer matrix material in a second compounding operation to form pellets;
pre-magnetizing the pellets with the high coercivity particles;
molding the security device using the two set of pellets, resulting in a uniform low coercivity background material with random individual magnetized particles in this matrix.

5. The method of claim 4, wherein the first and second polymer matrix materials are the same.

6. The method of claim 5, wherein the low coercivity material is magnetite.

7. The method of claim 6, wherein the high coercivity material is an alloy of neodymium, iron, and boron.

8. A method of making a security device with both permanent and non-permanent content comprising:
compounding low coercivity material with a first polymer matrix material in a first compounding operation to form pellets;
compounding high coercivity particles with a second polymer matrix material in a second compounding operation to form pellets;
pre-magnetizing the pellets with the high coercivity particles;
molding the low coercivity pellets and high coercivity pellets in a co-injection operation to create a part having regions with low coercivity and regions with high coercivity particles within the same part.

9. The method of claim 8, wherein the first and second polymer matrix materials are the same.

10. The method of claim 9, wherein the low coercivity material is magnetite.

11. The method of claim 10, wherein the high coercivity material is an alloy of neodymium, iron, and boron.

12. A method of making a magnetic physical unclonable object comprising:
incorporating a magnetizable feed stock of a fine powder with a mean particle size less than 100 microns into a resin with higher melt temperatures to delay the melting point in an injection molding machine until shortly before the resin matrix reaches an injection nozzle;
applying an alternating magnetic field to the melted feed stock shortly entering the molding cavity to magnetize the low coercivity particles; and
injection molding the melted feed stock.

13. A method of making a magnetic physical unclonable object comprising:
incorporating a blend of magnetizable feedstocks to make pellets, where a first feedstock contains approximately 20 to 30% particles of an allow of neodymium, iron, and boron by weight and a second feedstock contains approximately 20 to 40% magnetite particles by weight;
magnetizing the particles in the pellets before the pellets are placed in an injection molding machine; and
restricting the heating of a feed screw of the injection molding machine so that the feed screw provides limited melting of the mixing materials to produce a heterogeneous part.
